(19) United States
(12) Patent Application Publication
(10) Pub. No.: US 2019/0230310 A1
(43) Pub. Date: Jul. 25, 2019

(54) INTELLIGENT CONTENT POPULATION IN A COMMUNICATION SYSTEM

(71) Applicant: MICROSOFT TECHNOLOGY LICENSING, LLC, Redmond, WA (US)

(72) Inventor: Jason Thomas FAULKNER, Seattle, WA (US)

(21) Appl. No.: 15/879,263

(22) Filed: Jan. 24, 2018

(51) Int. Cl. H04N 5/445; H04N 7/15; G06K 9/00; H04N 5/262

(52) U.S. Cl. CPC H04N 5/44591; H04N 7/157; H04N 5/2628; G06K 9/00228; G06K 9/00281; H04N 7/15

(57) ABSTRACT

A communication system may provide a user interface that includes sections or areas populated with video feeds and/or still images associated with a communication session. A first of the sections may be populated with a video feed or still image of a presenter in the communication session. A second of the sections may be populated with a video feed or still image of an audience member of the video conference that is interacting with the presenter. The communication system may arrange the video feeds or still images to properly represent an interaction between the audience member and the presenter in the communication session, or the communication system may adjust an orientation of one or more of the video feeds or still images to properly represent the interaction between the audience member and the presenter.

### BACKGROUND

The use of communication (e.g., conference, videoconference, teleconference, etc.) systems in personal and commercial settings has increased dramatically so that meetings between people in remote locations can be facilitated. In general, communication systems allow users, in two or more remote locations, to communicate interactively with each other via live or recorded, simultaneous two-way video streams, audio streams, or both. Some communication systems (e.g., CISCO WEBEX provided by CISCO SYSTEMS, Inc. of San Jose, Calif., GOTOMEETING provided by CITRIX SYSTEMS, INC. of Santa Clara, Calif., ZOOM provided by ZOOM VIDEO COMMUNICATIONS of San Jose, Calif., GOOGLE HANGOUTS by ALPHABET INC. of Mountain View, Calif., and SKYPE FOR BUSINESS provided by the MICROSOFT CORPORATION, of Redmond, Wash.) also allow users to share display screens that present, for example, images, text, video, applications, and any other content items that are rendered on the display screen(s) the user is sharing.

Communication systems provide a reasonable substitute for in person meetings. State-of-the-art video communication systems may provide dedicated cameras and monitors to one or two or more users, utilize innovative room arrangements to make the remote participants feel like they are in the same room by placing monitors and speakers at locations where a remote meeting participant would be sitting, if they were attending in person. Such systems better achieve a face-to-face communication paradigm wherein meeting participants can view facial expressions and body language that may not be achieved in a general communication session.

Some communication systems may provide a user interface that has a grid format. Each section of the grid format may be populated with one or more participants of a video communication session. For example, a first grid section may be populated with a video feed or still image of a presenter in the video communication session, a second grid section may be populated with a video feed or still image of an individual interacting with the presenter, a third grid section may be populated with a video feed or still image of an audience member, and so forth. The video or image represented orientation or positioning of the presenter, the individual interacting with the presenter, and/or the audience member are generally dictated by the source (e.g., video camera) providing the video feed or still image populating an associated grid of the user interface. However, the represented orientation and/or positioning of the video feeds and/or images in the grids of the user interface may be incorrect based on the context of the communication session.

### SUMMARY

A communication system may provide a user interface that includes sections or areas populated with video feeds and/or still images associated with a communication session. A first of the sections may be populated with a video feed or still image of a presenter in the communication session. A second of the sections may be populated with a video feed or still image of an audience member of the communication session that is interacting with the presenter. The communication system may arrange the video feeds or still images to properly represent an interaction between the audience member and the presenter in the communication session, or the communication system may adjust an orientation of one or more of the video feeds or still images to properly represent the interaction between the audience member and the presenter.

Positioning of a video camera associated with the communication system may incorrectly result in a video feed that shows that the audience member is facing away from the presenter. The context of communication data of the communication system, such as the interaction between the audience member and the presenter, the audience member gesturing to the presenter, and/or the audience member looking at the presenter, may cause the communication system to arrange (i.e. flip) the video feed of the audience member to properly represent in an associated section of the user interface that the audience member is facing the presenter. Using context of the communication data, the system may also adjust section position, scaling, eye gaze, zoom, focus, and the like, to enhance the user interface of the communication system. Image flip correction, scale correction, eye alignment, gesture alignment and the like resolve in-frame subject continuity issues that occur within a single (or reframed) sequence or multiple camera angle views that that populate the communication system user interface.

In some implementations, the context of the communication data may be determined using face recognition technology. For example, facial recognition technology may be used to determine that the audience member is looking at or facing the presenter, or that the audience member is looking away or not facing the presenter. For example, face recognition technology is able to analyze facial features (e.g., eyes, ears, nose, face shadowing, etc.) to determine in which direction a face rendered in an image, video or avatar is directed.

In some implementations, a system may include one or more processing units, and a computer-readable medium having encoded thereon computer-executable instructions to cause the one or more processing units to provide a presentation graphical user interface (GUI), the presentation GUI including a plurality of grid sections to be populated with video feeds or still images associated with communication data, analyze the video feeds or the still images associated with the communication data to ascertain a context associated with the video feeds or the still images, populate a first of the plurality of grid sections with a first video feed or a first still image of the video feeds or the still images, and populate a second of the plurality of grid sections with a second video feed or a second still image of the video feeds or the still images, wherein populating the second of the plurality of grid sections includes adjusting a presentation of the second video feed or the second still image based on the context associated with the video feeds or the still images associated with the communication data.

Furthermore, in some implementations, a method may include providing a presentation graphical user interface (GUI), the presentation GUI to be populated with video feeds or still images associated with communication data, analyzing the video feeds or the still images associated with the communication data to ascertain a context associated with the video feeds or the still images, populating the presentation GUI with a first video feed or a first still image of the video feeds or the still images, and populating the presentation GUI with a second video feed or a second still image of the video feeds or the still images, wherein populating the presentation GUI with the second video feed or the second still image includes adjusting a presentation of the second video feed or the second still image based on the context associated with the video feeds or the still images associated with the communication data.

Additionally, in some implementations, a non-transitory computer readable medium having stored thereon software instructions that, when executed by a computer, cause the computer to perform operations including providing a presentation graphical user interface (GUI), the presentation GUI to be populated with video feeds associated with communication data, analyzing the video feeds associated with the communication data to ascertain a context associated with the video feeds, populating the presentation GUI with a first video feed of the video feeds, and populating the presentation GUI with a second video feed of the video feeds, wherein populating the presentation GUI with the second video feed includes adjusting a presentation of the second video feed based on the context associated with the video feeds associated with the communication data.

In some implementations, a method may include providing a presentation graphical user interface (GUI), the presentation GUI to be populated with video feeds or still images associated with communication data. Furthermore, the method may include analyzing the video feeds or the still images associated with the communication data to ascertain a context associated with the video feeds or the still images, populating the presentation GUI with a first video feed or a first still image of the video feeds or the still images, and populating the presentation GUI with a second video feed or a second still image of the video feeds or the still images. Populating the presentation GUI with the second video feed or the second still image may include adjusting a presentation of the second video feed or the second still image based on the context associated with the video feeds or the still images associated with the communication data.

In some implementations, a system may include one or more processing units; and a computer-readable medium having encoded thereon computer-executable instructions. The computer-executable instructions may to cause the one or more processing units to provide a presentation graphical user interface (GUI), the presentation GUI to be populated with video feeds or still images associated with communication data, and analyze the video feeds or the still images associated with the communication data to ascertain a context associated with the video feeds or the still images. Furthermore, the computer-executable instructions may cause the one or more processing units to populate the presentation GUI with a first video feed or a first still image of the video feeds or the still images, and populate the presentation GUI with a second video feed or a second still image of the video feeds or the still images, wherein populating the presentation GUI is at least based on the context associated with the video feeds or the still images.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWING

The detailed description is described with reference to the accompanying figures. In the figures, the left-most digit(s) of a reference number identifies the figure in which the reference number first appears. The same reference numbers in different figures indicate similar or identical items.

FIG. 1 is a diagram illustrating an example environment in which a system can operate to populate a graphical user interface (GUI) with video content, image content and/or presentation content.

FIG. 2 illustrates a diagram that shows example components of an example device configured populate a presentation GUI that may include a plurality of sections or grids that may render or comprise video, image, and/or content for display on a display screen.

FIG. 3A illustrates an exemplary presentation GUI configured to display a persistent view that includes a plurality of distinct regions, sections, areas, or grids that each correspond to a particular participant of a communication session.

FIG. 3B illustrates another exemplary presentation GUI configured to display a persistent view that includes a plurality of distinct regions, sections, areas, or grids that each correspond to a particular participant of a communication session.

FIG. 3C illustrates another exemplary presentation GUI configured to display a persistent view that includes a plurality of distinct regions, sections, areas, or grids that each correspond to a particular participant of a communication session.

FIG. 4 is a diagram of an example flowchart that illustrates operations directed to displaying an exemplary presentation GUI according to the described implementations.

FIG. 5 illustrates another exemplary presentation GUI configured to display a persistent view that includes a plurality of distinct regions, sections, areas, or grids that each correspond to a particular participant of a communication session.

### DETAILED DESCRIPTION

Described implementations may provide a user interface, associated with a communication system, that includes sections or areas populated with video feeds and/or still images. For example, the communication system may provide a user interface that includes sections or areas populated with video feeds and/or still images associated with a communication session. A first of the sections may be populated with a video feed or still image of a presenter in the communication session. A second of the sections may be populated with a video feed or still image of an audience member of the communication session that is interacting with the presenter. The communication system may arrange the video feeds or still images to properly represent an interaction between the audience member and the presenter in the communication session, or the communication system may adjust an orientation of one or more of the video feeds or still images to properly represent the interaction between the audience member and the presenter.

In some implementations, a first of the sections may be populated with a video feed or still image of a presenter in a video conference. Additionally, a second of the sections may be populated with a video feed or still image of an audience member of the video conference that is interacting with the presenter. The communication system may adjust an orientation of one or more of the video feeds or still images to properly represent the interaction between the audience member and the presenter. For example, positioning of a video camera associated with the communication system may incorrectly result in a video feed that shows that the audience member is facing away from the presenter. The context of communication data of the communication system, such as the interaction between the audience member and the presenter, may cause the communication system to arrange (i.e. flip) the video feed of the audience member to properly represent in an associated section of the user interface that the audience member is facing the presenter. Using context of the communication data, the system may also adjust section position, scaling, eye gaze, zoom, focus, and the like, to enhance the user interface of the communication system. Image flip correction, scale correction, eye alignment, gesture alignment and the like resolve in-frame subject continuity issues that occur within a single (or reframed) sequence or multiple camera angle views that that populate the communication system user interface.

In some implementations, the context of the communication data may be determined using face recognition technology. For example, facial recognition technology may be used to determine that the audience member is looking at or facing the presenter, or that the audience member is looking away or not facing the presenter. For example, face recognition technology is able to analyze facial features (e.g., eyes, ears, nose, face shadowing, etc.) to determine in which direction a face rendered in an image, video or avatar is directed.

In some implementations, a system may include one or more processing units, and a computer-readable medium having encoded thereon computer-executable instructions to cause the one or more processing units to provide a presentation graphical user interface (GUI), the presentation GUI including a plurality of grid sections to be populated with video feeds or still images associated with communication data, analyze the video feeds or the still images associated with the communication data to ascertain a context associated with the video feeds or the still images, populate a first of the plurality of grid sections with a first video feed or a first still image of the video feeds or the still images, and populate a second of the plurality of grid sections with a second video feed or a second still image of the video feeds or the still images, wherein populating the second of the plurality of grid sections includes adjusting a presentation of the second video feed or the second still image based on the context associated with the video feeds or the still images associated with the communication data.

Furthermore, in some implementations, a method may include providing a presentation graphical user interface (GUI), the presentation GUI to be populated with video feeds or still images associated with communication data, analyzing the video feeds or the still images associated with the communication data to ascertain a context associated with the video feeds or the still images, populating the presentation GUI with a first video feed or a first still image of the video feeds or the still images, and populating the presentation GUI with a second video feed or a second still image of the video feeds or the still images, wherein populating the presentation GUI with the second video feed or the second still image includes adjusting a presentation of the second video feed or the second still image based on the context associated with the video feeds or the still images associated with the communication data.

Additionally, in some implementations, a non-transitory computer readable medium having stored thereon software instructions that, when executed by a computer, cause the computer to perform operations including providing a presentation graphical user interface (GUI), the presentation GUI to be populated with video feeds associated with communication data, analyzing the video feeds associated with the communication data to ascertain a context associated with the video feeds, populating the presentation GUI with a first video feed of the video feeds, and populating the presentation GUI with a second video feed of the video feeds, wherein populating the presentation GUI with the second video feed includes adjusting a presentation of the second video feed based on the context associated with the video feeds associated with the communication data.

In some implementations, a method may include providing a presentation graphical user interface (GUI), the presentation GUI to be populated with video feeds or still images associated with communication data. Furthermore, the method may include analyzing the video feeds or the still images associated with the communication data to ascertain a context associated with the video feeds or the still images, populating the presentation GUI with a first video feed or a first still image of the video feeds or the still images, and populating the presentation GUI with a second video feed or a second still image of the video feeds or the still images. Populating the presentation GUI with the second video feed or the second still image may include adjusting a presentation of the second video feed or the second still image based on the context associated with the video feeds or the still images associated with the communication data.

In some implementations, a system may include one or more processing units; and a computer-readable medium having encoded thereon computer-executable instructions. The computer-executable instructions may to cause the one or more processing units to provide a presentation graphical user interface (GUI), the presentation GUI to be populated with video feeds or still images associated with communication data, and analyze the video feeds or the still images associated with the communication data to ascertain a context associated with the video feeds or the still images. Furthermore, the computer-executable instructions may cause the one or more processing units to populate the presentation GUI with a first video feed or a first still image of the video feeds or the still images, and populate the presentation GUI with a second video feed or a second still image of the video feeds or the still images, wherein populating the presentation GUI is at least based on the context associated with the video feeds or the still images.

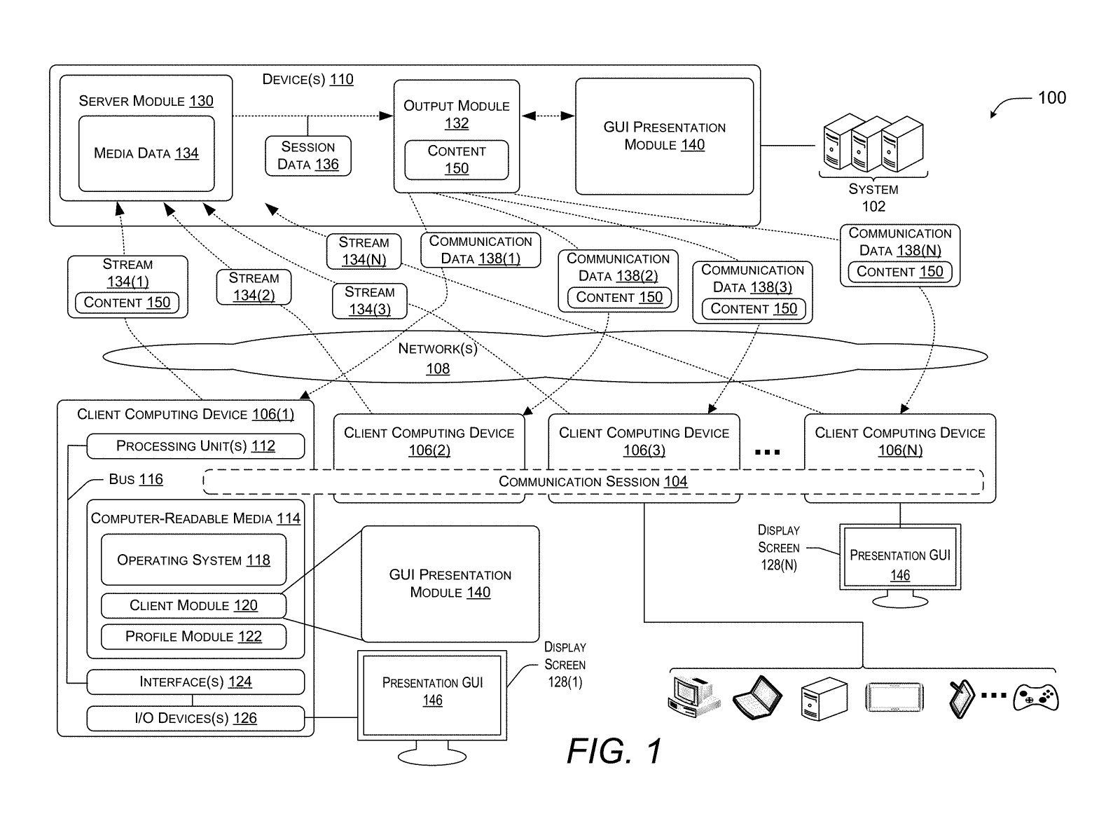

Various examples, implementations, scenarios, and aspects are described below with reference to FIGS. 1 through 5.

FIG. 1 is a diagram illustrating an example environment 100 in which a system 102 can operate to populate a graphical user interface (GUI) with video content, image content and/or presentation content. In this example, the communication session 104 is implemented between a number of client computing devices 106(1) through 106(N) (where N is a positive integer number having a value of two or greater) that are associated with the system 102 or are part of the system 102. The client computing devices 106(1) through 106(N) enable users to participate in the communication session 104.

In this example, the communication session 104 is hosted, over one or more network(s) 108, by the system 102. That is, the system 102 can provide a service that enables users of the client computing devices 106(1) through 106(N) to participate in the communication session 104 (e.g., via a live viewing and/or a recorded viewing). Consequently, a “participant” to the communication session 104 can comprise a user and/or a client computing device (e.g., multiple users may be in a communication room participating in a communication session via the use of a single client computing device), each of which can communicate with other participants. As an alternative, the communication session 104 can be hosted by one of the client computing devices 106(1) through 106(N) utilizing peer-to-peer technologies. The system 102 can also host chat conversations and other team collaboration functionality (e.g., as part of an application suite). In one example, a chat conversation can be conducted in accordance with the communication session 104. Additionally, the system 102 may host the communication session 104, which includes at least a plurality of participants co-located at a meeting location, such as a meeting room or auditorium.

In examples described herein, client computing devices 106(1) through 106(N) participating in the communication session 104 are configured to receive and render for display, on a user interface of a display screen, communication data. The communication data can comprise a collection of various instances, or streams, of live content and/or recorded content. The collection of various instances, or streams, of life content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

The system 102 includes device(s) 110. The device(s) 110 and/or other components of the system 102 can include distributed computing resources that communicate with one another and/or with the client computing devices 106(1) through 106(N) via the one or more network(s) 108. In some examples, the system 102 may be an independent system that is tasked with managing aspects of one or more communication sessions such as communication session 104. As an example, the system 102 may be managed by entities such as SLACK, WEBEX, GOTOMEETING, GOOGLE HANGOUTS, etc.

Network(s) 108 may include, for example, public networks such as the Internet, private networks such as an institutional and/or personal intranet, or some combination of private and public networks. Network(s) 108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 108 may utilize communications protocols, including packet-based and/or datagram-based protocols such as Internet protocol (“IP”), transmission control protocol (“TCP”), user datagram protocol (“UDP”), or other types of protocols. Moreover, network(s) 108 may also include a number of devices that facilitate network communications and/or form a hardware basis for the networks, such as switches, routers, gateways, access points, firewalls, base stations, repeaters, backbone devices, and the like.

In some examples, network(s) 108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 110 may include one or more computing devices that operate in a cluster or other grouped configuration to share resources, balance load, increase performance, provide fail-over support or redundancy, or for other purposes. For instance, device(s) 110 may belong to a variety of classes of devices such as traditional server-type devices, desktop computer-type devices, and/or mobile-type devices. Thus, although illustrated as a single type of device or a server-type device, device(s) 110 may include a diverse variety of device types and are not limited to a particular type of device. Device(s) 110 may represent, but are not limited to, server computers, desktop computers, web-server computers, personal computers, mobile computers, laptop computers, tablet computers, or any other sort of computing device.

A client computing device (e.g., one of client computing device(s) 106(1) through 106(N)) may belong to a variety of classes of devices, which may be the same as, or different from, device(s) 110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 106(1) through 106(N) of the various classes and device types can represent any type of computing device having one or more processing unit(s) 112 operably connected to computer-readable media 114 such as via a bus 116, which in some instances can include one or more of a system bus, a data bus, an address bus, a PCI bus, a Mini-PCI bus, and any variety of local, peripheral, and/or independent buses.

Executable instructions stored on computer-readable media 114 may include, for example, an operating system 118, a client module 120, a profile module 122, and other modules, programs, or applications that are loadable and executable by processing units(s) 112.

Client computing device(s) 106(1) through 106(N) may also include one or more interface(s) 124 to enable communications between client computing device(s) 106(1) through 106(N) and other networked devices, such as device(s) 110, over network(s) 108. Such network interface(s) 124 may include one or more network interface controllers (NICs) or other types of transceiver devices to send and receive communications and/or data over a network. Moreover, client computing device(s) 106(1) through 106(N) can include input/output (“I/O”) interfaces 126 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 1 illustrates that client computing device 106(1) is in some way connected to a display device (e.g., a display screen 128(1)), which can display a GUI according to the techniques described herein.

In the example environment 100 of FIG. 1, client computing devices 106(1) through 106(N) may use their respective client modules 120 to connect with one another and/or other external device(s) in order to participate in the communication session 104, or in order to contribute activity to a collaboration environment. For instance, a first user may utilize a client computing device 106(1) to communicate with a second user of another client computing device 106(2). When executing client modules 120, the users may share data, which may cause the client computing device 106(1) to connect to the system 102 and/or the other client computing devices 106(2) through 106(N) over the network(s) 108.

The client computing device(s) 106(1) through 106(N) may use their respective profile module 122 to generate participant profiles, and provide the participant profiles to other client computing devices and/or to the device(s) 110 of the system 102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 1, the device(s) 110 of the system 102 includes a server module 130 and an output module 132. In this example, the server module 130 is configured to receive, from individual client computing devices such as client computing devices 106(1) through 106(N), media streams 134(1) through 134(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 130 is configured to receive a collection of various media streams 134(1) through 134(N) during a live viewing of the communication session 104 (the collection being referred to herein as media data 134). In some scenarios, not all the client computing devices that participate in the communication session 104 provide a media stream. For example, a client computing device may only be a consuming, or a “listening”, device such that it only receives content associated with the communication session 104 but does not provide any content to the communication session 104.

In various examples, the server module 130 can select aspects of the media data 134 that are to be shared with individual ones of the participating client computing devices 106(1) through 106(N). Consequently, the server module 130 may be configured to generate session data 136 based on the streams 134 and/or pass the session data 136 to the output module 132. Then, the output module 132 may communicate communication data 138 to the client computing devices (e.g., client computing devices 106(1) through 106(3) participating in a live viewing of the communication session). The communication data 138 may include video, audio, and/or other content data, provided by the output module 132 based on content 150 associated with the output module 132 and based on received session data 136. As shown, the output module 132 transmits communication data 138(1) to client computing device 106(1), and transmits communication data 138(2) to client computing device 106(2), and transmits communication data 138(3) to client computing device 106(3), etc. The communication data 138 transmitted to the client computing devices can be the same or can be different (e.g., positioning of streams of content within a user interface may vary from one device to the next).

In various implementations, the device(s) 110 and/or the client module 120 can include GUI presentation module 140. The GUI presentation module 140 may be configured to analyze communication data 138 that is for delivery to one or more of the client computing devices 106. Specifically, the GUI presentation module 140, at the device 110 and/or the client computing device 106, may analyze communication data 138 to determine an appropriate manner for displaying video, image, and/or content on the display screen 128 of an associated client computing device 106. In some implementations, the GUI presentation module 140 may provide video, image, and/or content to a presentation GUI 146 rendered on the display screen 128 of the associated client computing device 106. The presentation GUI 146 may be caused to be rendered on the display screen 128 by the GUI presentation module 140. The presentation GUI 146 may include the video, image, and/or content analyzed by the GUI presentation module 140.

In some implementations, the presentation GUI 146 may include a plurality of sections or grids that may render or comprise video, image, and/or content for display on the display screen 128. For example, a first section of the presentation GUI 146 may include a video feed of a presenter or individual, a second section of the presentation GUI 146 may include a video feed of an individual consuming meeting information provided by the presenter or individual. The GUI presentation module 140 may populate the first and second sections of the presentation GUI 146 in a manner that properly imitates an environment experience that the presenter and the individual may be sharing. In some implementations, the GUI presentation module 140 may alter the video feed of the individual to properly represent that the individual is looking at the presenter. For example, the GUI presentation module 140 may flip, arrange, rotate or otherwise alter the positioning of the individual represented by the video feed in order to properly represent that the individual is looking at the presenter. Furthermore, in some implementations, the GUI presentation module 140 may enlarge or provide a zoomed view of the individual represented by the video feed in order to highlight a reaction, such as a facial feature, the individual had to the presenter.

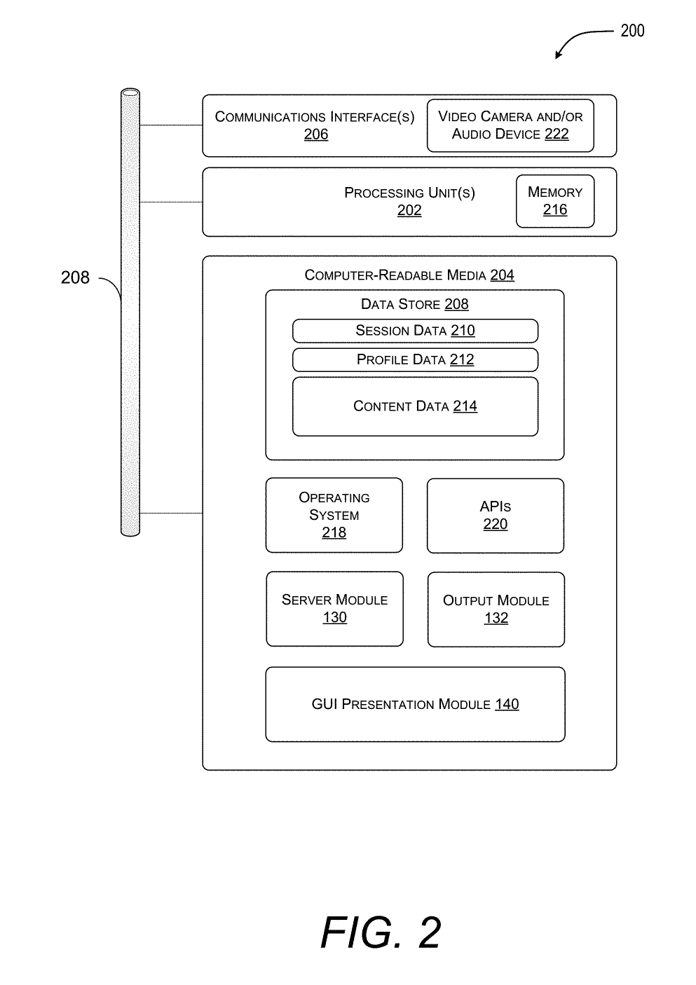

FIG. 2 illustrates a diagram that shows example components of an example device 200 configured populate the presentation GUI 146 that may include a plurality of sections or grids that may render or comprise video, image, and/or content for display on the display screen 128. The device 200 may represent one of device(s) 110. Additionally, or alternatively, the device 200 may represent one of the client computing devices 106. As illustrated, the device 200 includes one or more processing unit(s) 202, computer-readable media 204, and communication interface(s) 206. The components of the device 200 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 202 and/or processing unit(s) 112, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 204 and/or computer-readable media 114, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 206 may represent, for example, network interface controllers (“NICs”) or other types of transceiver devices to send and receive communications over a network. Furthermore, the communication interface(s) 206 may include one or more video cameras and/or audio devices 222 to enable generation of video feeds and/or still images, and so forth.

In the illustrated example, computer-readable media 204 includes a data store 208. In some examples, data store 208 includes data storage such as a database, data warehouse, or other type of structured or unstructured data storage. In some examples, data store 208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XIVIL”) tables, for example.

The data store 208 may store data for the operations of processes, applications, components, and/or modules stored in computer-readable media 204 and/or executed by processing unit(s) 202 and/or accelerator(s). For instance, in some examples, data store 208 may store session data 210 (e.g., session data 136), profile data 212 (e.g., associated with a participant profile), and/or other data. The session data 210 can include a total number of participants (e.g., users and/or client computing devices) in a communication session, activity that occurs in the communication session, a list of invitees to the communication session, and/or other data related to when and how the communication session is conducted or hosted. The data store 208 may also include content data 214, such as the content 150 that includes video, audio, or other content for rendering and display on one or more of the display screens 128.

Alternately, some or all of the above-referenced data can be stored on separate memories 216 on board one or more processing unit(s) 202 such as a memory on board a CPU-type processor, a GPU-type processor, an FPGA-type accelerator, a DSP-type accelerator, and/or another accelerator. In this example, the computer-readable media 204 also includes operating system 218 and application programming interface(s) 220 configured to expose the functionality and the data of the device 200 to other devices. Additionally, the computer-readable media 204 includes one or more modules such as the server module 130, the output module 132, and the GUI presentation module 140, although the number of illustrated modules is just an example, and the number may vary higher or lower. That is, functionality described herein in association with the illustrated modules may be performed by a fewer number of modules or a larger number of modules on one device or spread across multiple devices.

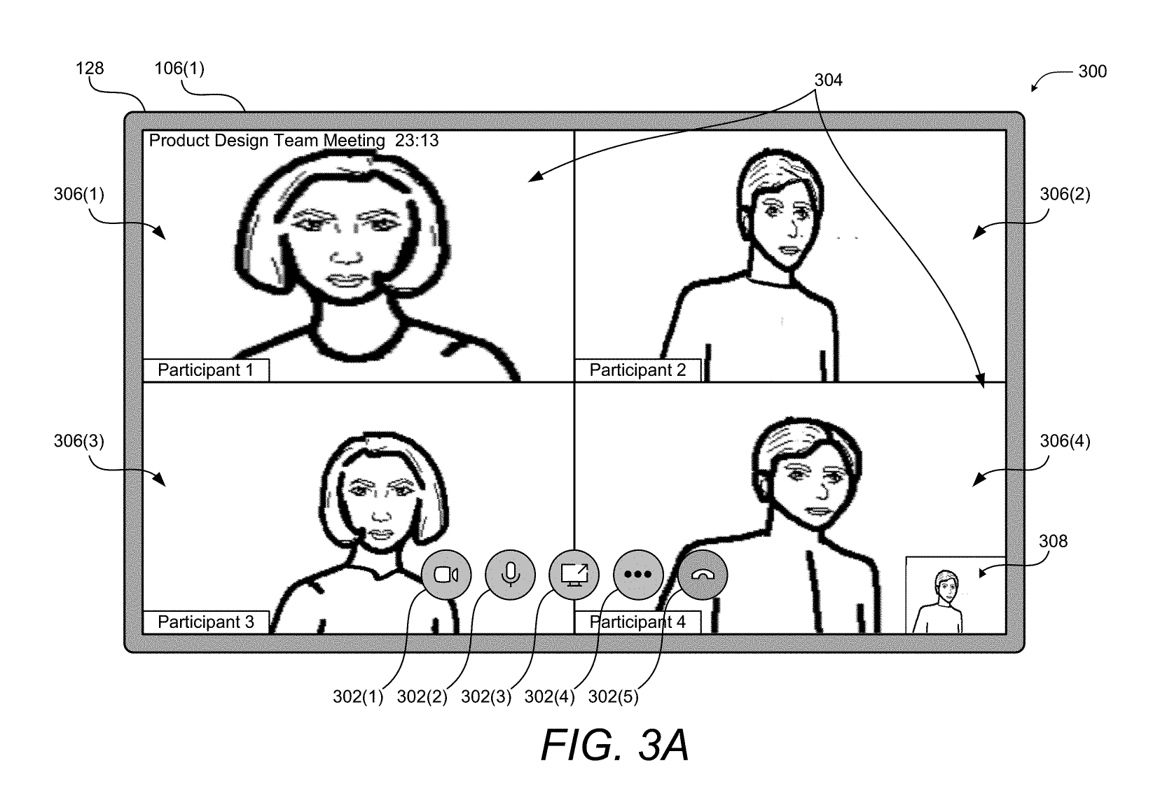

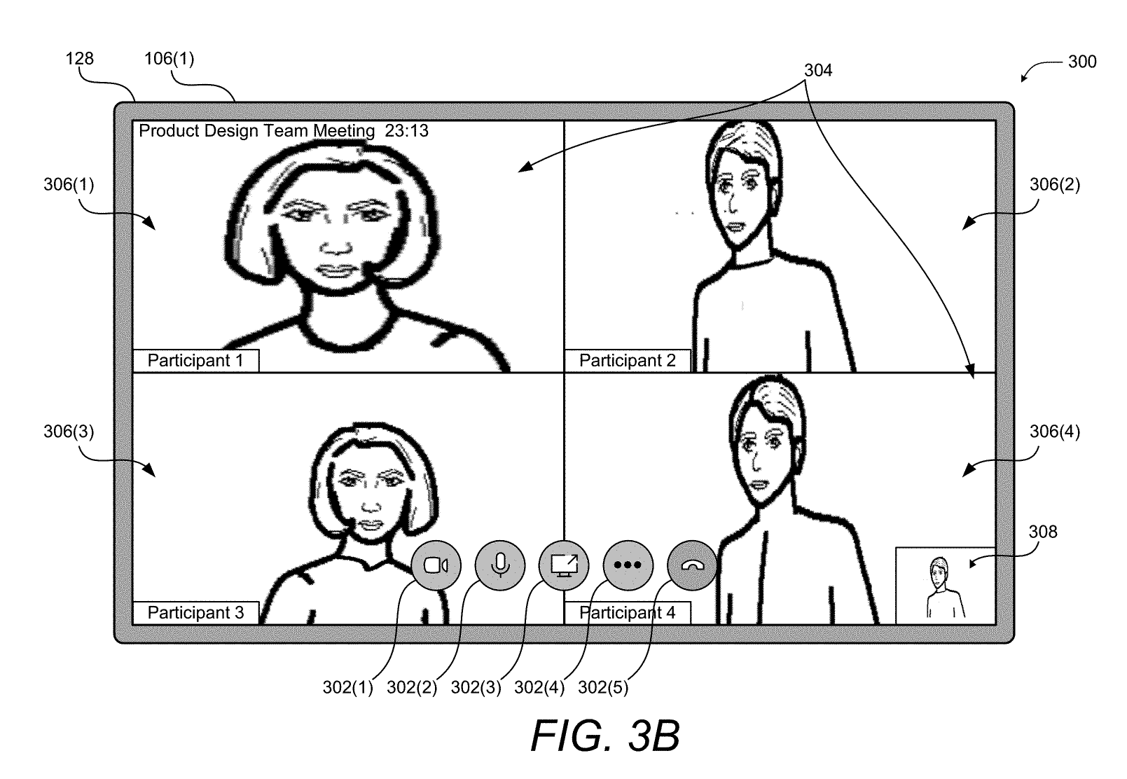

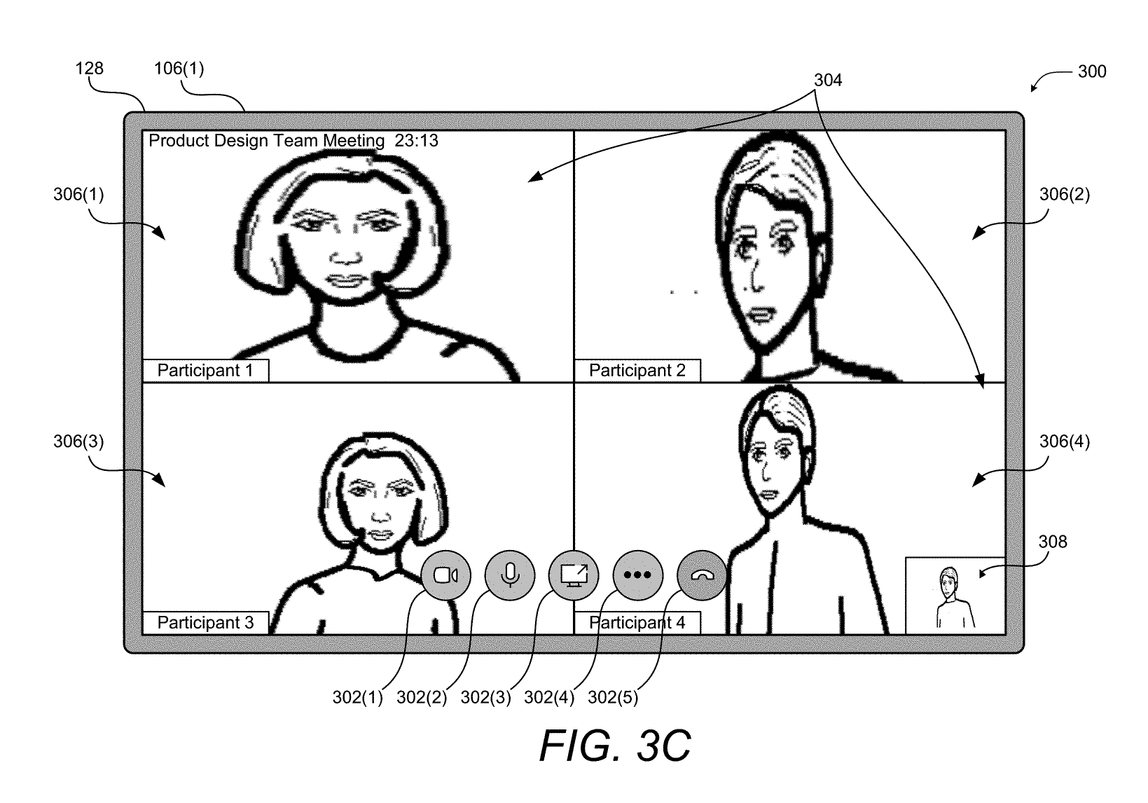

FIG. 3A illustrates an exemplary presentation GUI 300 configured to display a persistent view 304 that includes four distinct regions, sections, areas, or grids 306 that each correspond to a particular participant of a communication session 104. The presentation GUI 300 may include any number of sections 306. Therefore, the illustrated four sections 306 are exemplary. In some implementations, one or more of the grids 306 may correspond to a particular participant in the communication session 104, yet one or more of the grids 306 may alternatively display an avatar associated with a particular participant. The following description applies to communication feeds that include participant renderings, avatar renderings, content renderings, and the like.

The persistent view 304 may be associated with a “stage” of the communication session 104 that is occupied by the most relevant speakers and/or content of the communication session 104 at any particular time. For example, the system 102 may identify which participant and/or participants are the most dominant during the communication session 104 (or portions thereof) to determine which participants to display within the persistent view 304.

When multiple participants are displayed within the persistent view 304, the system 102 may identify in which portion of the display 128 each participant is to be displayed. For example, in the illustrated scenario, the persistent view 304 includes four distinct regions, sections, areas or grids labeled 306(1) through 306(4) that each correspond to a particular participant of the communication session 104. In this particular example, a first region 306(1) corresponds to a first participant “Participant 1” that is a most dominant participant, a second region 306(2) corresponds to a second participant “Participant 2” that is a second-most dominant participant, etc. For example, the first participant “Participant 1” may be actively presenting or speaking in the communication session 104, and the second participant “Participant 2” may be consuming that which the first participant is actively presenting. Similarly, the third participant “Participant 3” and the fourth participant “Participant 4” may also be consuming that which the first participant is actively presenting. However, it appears that the second and fourth participants are looking away from the first participant. Therefore, the exemplary presentation GUI 300 does not properly show that the second and fourth participants are consuming that which the first participant is actively presenting.

As illustrated, the GUI 300 may also include five user interface elements (UIE) 302 labeled 302(1) through 302(5). More specifically, the GUI 300 may include a video on/off UIE 302(1) to enable the user to control whether video is streamed from the user's client computing device in association with the communication session 104, an audio on/off UIE 302(2) to enable the user to control whether audio is streamed from the user's client computing device in association with the communication session 104, a share-control UIE 302(3) to enable the user to selectively expose and/or hide a share-tray GUI, an additional control UIE 302(4) to enable the user to selectively expose and/or hide additional controls in association with the communication session 104, and a “hang up” UIE 302(5) to enable the user to exit the communication session 104.

In various implementations, the relative dominance of one or more participants with respect to other participants may be determined automatically by the system 102 based on various factors such as, for example, an amount of audio content streaming in association with that participant's client device (e.g., if a particular user is speaking the most during the communication session 104 the system 102 may determine that participant to be the most dominant participant), whether a particular participant is currently sharing content such as a display screen or a video file in association with the communication session 104, or any other factor suitable for determining which stream(s) 134 are should be rendered within the persistent view 304 and/or particular regions 306 thereof. As further illustrated, the GUI 300 may include a mirror-view region 308 that displays to the user on the user's own device how the user appears to other participants of the communication session 104 within a corresponding region 306 on the other participants' client computing devices.

FIG. 3B illustrates another exemplary presentation GUI 300 configured to display the persistent view 304 that includes four distinct regions, sections, areas, or grids 306 that each correspond to a particular participant of a communication session 104. The presentation GUI 300 may include any number of sections 306. Therefore, the illustrated four sections 306 are exemplary. FIG. 3B illustrates the exemplary presentation GUI 300 of FIG. 3A, with the presentation of the second and fourth participants adjusted to properly show that they are observing the first participant. In some implementations, one or more of the grids 306 may correspond to a particular participant in the communication session 104, yet one or more of the grids 306 may alternatively display an avatar associated with a particular participant. The following description applies to communication feeds that include participant renderings, avatar renderings, content renderings, and the like.

The persistent view 304 may be associated with a “stage” of the communication session 104 that is occupied by the most relevant speakers and/or content of the communication session 104 at any particular time. For example, the system 102 may identify which participant and/or participants are the most dominant during the communication session 104 (or portions thereof) to determine which participants to display within the persistent view 304. When multiple participants are displayed within the persistent view 304, the system 102 may identify in which portion of the display 128 each participant is to be displayed.

For example, in the illustrated scenario, the persistent view 304 includes four distinct regions, sections, areas or grids labeled 306(1) through 306(4) that each correspond to a particular participant of the communication session 104. In this particular example, the first region 306(1) corresponds to the first participant that is a most dominant participant, the second region 306(2) corresponds to the second participant that is a second-most dominant participant, etc. For example, the first participant may be actively presenting or speaking in the communication session 104, and the second participant may be consuming that which the first participant is actively presenting. Similarly, the third participant and the fourth participant may also be consuming that which the first participant is actively presenting.

The implementation illustrated in FIG. 3B shows that the system 102 altered the orientation of some of the participants rendered or populated in the sections 306. For example, a display of the second participant has been flipped to properly show that the second participant is observing the first participant. Similarly, a display of the fourth participant has been flipped to properly show that the fourth participant is also observing the first participant.

In some implementations, the system 102 analyzes a context of the communication session 104 and the associated communication data 138 when adjusting or modifying the display of one or more participants associated with the exemplary presentation GUI 300. In some implementations, the system 102, as part of the context analysis, determines if there is a dominant participant active in the communication session 104. The system 102 may determine that a participant is dominating the communication session 104 based on a percentage of time that the participant is active in the communication session 104. For example, the system 100 to may determine a participant is dominating the communication session 104 based on verbal activity, sharing of content, the participant who organized the communication session 104, and so forth. In other implementations, the dominant participant in the communication session 104 may be predetermined. The relative dominance of one or more participants with respect to other participants is discussed in greater detail in the following.

In some implementations, the system 102 analyzes the context of the communication session 104 using at least face recognition technology. For example, facial recognition technology may be used to determine that the audience member is looking at or facing the presenter, or that the audience member is looking away or not facing the presenter. For example, face recognition technology is able to analyze facial features (e.g., eyes, ears, nose, face shadowing, etc.) to determine in which direction a face rendered in an image, video or avatar is directed.

As illustrated, the GUI 300 may also include the five user interface elements (UIE) 302 labeled 302(1) through 302(5). More specifically, the GUI 300 may include the video on/off UIE 302(1) to enable the user to control whether video is streamed from the user's client computing device in association with the communication session 104, the audio on/off UIE 302(2) to enable the user to control whether audio is streamed from the user's client computing device in association with the communication session 104, the share-control UIE 302(3) to enable the user to selectively expose and/or hide a share-tray GUI, the additional control UIE 302(4) to enable the user to selectively expose and/or hide additional controls in association with the communication session 104, and the “hang up” UIE 302(5) to enable the user to exit the communication session 104.

In various implementations, the relative dominance of one or more participants with respect to other participants may be determined automatically by the system 102 based on various factors such as, for example, an amount of audio content streaming in association with that participant's client device (e.g., if a particular user is speaking the most during the communication session 104 the system 102 may determine that participant to be the most dominant participant), whether a particular participant is currently sharing content such as a display screen or a video file in association with the communication session 104, or any other factor suitable for determining which stream(s) 134 are should be rendered within the persistent view 304 and/or particular regions 306 thereof. As further illustrated, the GUI 300 may include a mirror-view region 308 that displays to the user on the user's own device how the user appears to other participants of the communication session 104 within a corresponding region 306 on the other participants' client computing devices.

FIG. 3C illustrates another exemplary presentation GUI 300 configured to display the persistent view 304 that includes four distinct regions, sections, areas, or grids 306 that each correspond to a particular participant of a communication session 104. The presentation GUI 300 may include any number of sections 306. Therefore, the illustrated four sections 306 are exemplary. FIG. 3C illustrates the exemplary presentation GUI 300 of FIG. 3A, with the presentation of the second and fourth participants adjusted to properly show that they are observing the first participant. Furthermore, FIG. 3C illustrates that the presentation of the second participant is further adjusted to enlarge or zoom in on the face of the second participant. It is to be understood that enlarging or zooming in on the face of the second participant, or any other portion of the rendering shown in the section 306, may be made in the absence of other adjustments to the presentation of the second participant.

In some implementations, one or more of the grids 306 may correspond to a particular participant in the communication session 104, yet one or more of the grids 306 may alternatively display an avatar associated with a particular participant. The foregoing and following description applies to communication feeds that include participant renderings, avatar renderings, content renderings, and the like.

The persistent view 304 may be associated with a “stage” of the communication session 104 that is occupied by the most relevant speakers and/or content of the communication session 104 at any particular time. For example, the system 102 may identify which participant and/or participants are the most dominant during the communication session 104 (or portions thereof) to determine which participants to display within the persistent view 304. When multiple participants are displayed within the persistent view 304, the system 102 may identify in which portion of the display 128 each participant is to be displayed.

For example, in the illustrated scenario, the persistent view 304 includes four distinct regions, sections, areas or grids labeled 306(1) through 306(4) that each correspond to a particular participant of the communication session 104. In this particular example, the first region 306(1) corresponds to the first participant that is a most dominant participant, the second region 306(2) corresponds to the second participant that is a second-most dominant participant, etc. For example, the first participant may be actively presenting or speaking in the communication session 104, and the second participant may be consuming that which the first participant is actively presenting. Similarly, the third participant and the fourth participant may also be consuming that which the first participant is actively presenting.

The implementation illustrated in FIG. 3C shows that the system 102 adjusted or altered the orientation of some of the participants rendered in the sections 306. For example, a display of the second participant has been flipped to properly show that the second participant is observing the first participant. Similarly, a display of the fourth participant has been flipped to properly show that the fourth participant is also observing first participant. In addition, in this implementation, the presentation of the second participant is further adjusted to enlarge or zoom in on the face of the second participant. The system 102 may enlarge or zoom in on the face of a participant when the system 102 determines that the participant is making one or more of a predetermined number of gestures. Those predetermined number of gestures may include smiling, frowning, gazing intently, the look of surprise, sadness, happiness, or the like. It is to be understood that enlarging or zooming in on the face of the second participant, or any other portion of the rendering shown in the section 306, may be made in the absence of other adjustments to the presentation of the second participant. Furthermore, in some implementations, the system 102 may crop, enlarge or zoom in on the face of a participant when the system 102 determines that adjusted or altered the orientation of one or more of the participants rendered in the sections 306 may cause image abnormalities in the adjusted or altered participate renderings. Such image abnormalities may include incorrect text (e.g., reversed text), video or image background abnormalities and the like. The system 102 may perform video or image cropping, enlarging or zooming to remove such image abnormalities when performing the adjusting or altering of the orientation of some of the participants rendered in the section 306.

In some implementations, the system 102 analyzes a context of the communication session 104 and the associated communication data 138 when adjusting or modifying the display of one or more participants associated with the exemplary presentation GUI 300. In some implementations, the system 102, as part of the context analysis, determines if there is a dominant participant active in the communication session 104. The system 102 may determine that a participant is dominating the communication session 104 based on a percentage of time that the participant is active in the communication session 104. For example, the system 102 may determine a participant is dominating the communication session 104 based on verbal activity, sharing of content, and so forth. In other implementations, the dominant participant in the communication session 104 may be predetermined. The relative dominance of one or more participants with respect to other participants is discussed in greater detail in the following.

As illustrated, the GUI 300 may also include the five user interface elements (UIE) 302 labeled 302(1) through 302(5). More specifically, the GUI 300 may include the video on/off UIE 302(1) to enable the user to control whether video is streamed from the user's client computing device in association with the communication session 104, the audio on/off UIE 302(2) to enable the user to control whether audio is streamed from the user's client computing device in association with the communication session 104, the share-control UIE 302(3) to enable the user to selectively expose and/or hide a share-tray GUI, the additional control UIE 302(4) to enable the user to selectively expose and/or hide additional controls in association with the communication session 104, and the “hang up” UIE 302(5) to enable the user to exit the communication session 104.

In various implementations, the relative dominance of one or more participants with respect to other participants may be determined automatically by the system 102 based on various factors such as, for example, an amount of audio content streaming in association with that participant's client device (e.g., if a particular user is speaking the most during the communication session 104 the system 102 may determine that participant to be the most dominant participant), whether a particular participant is currently sharing content such as a display screen or a video file in association with the communication session 104, or any other factor suitable for determining which stream(s) 134 are should be rendered within the persistent view 304 and/or particular regions 306 thereof. As further illustrated, the GUI 300 may include a mirror-view region 308 that displays to the user on the user's own device how the user appears to other participants of the communication session 104 within a corresponding region 306 on the other participants' client computing devices.

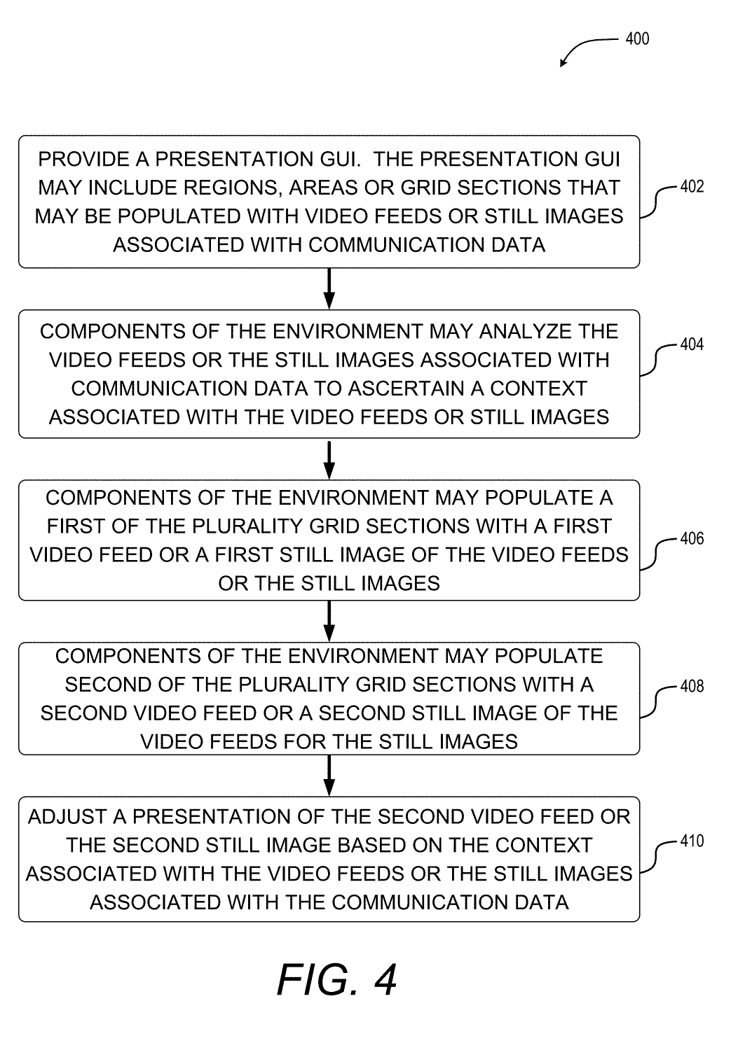

FIG. 4 illustrate an example flowchart. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system (e.g., system 102, device 110, client computing device 106(N), and/or device 200) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

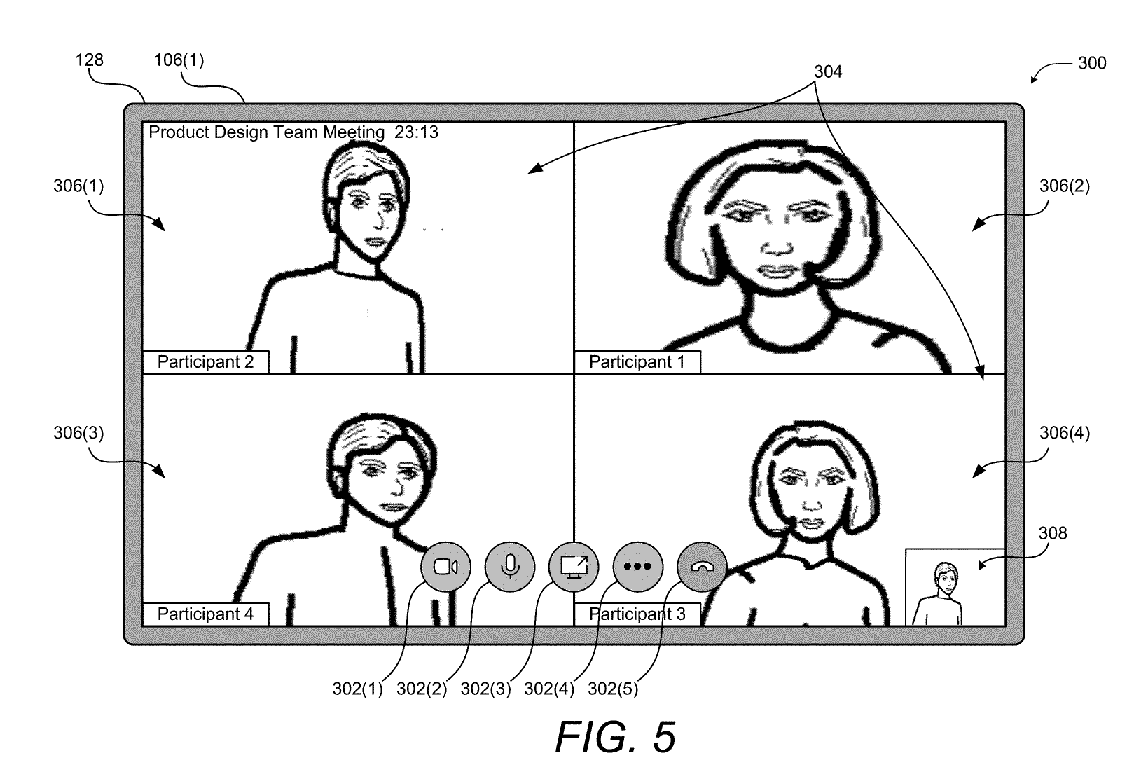

Additionally, the operations illustrated in FIG. 4 can be implemented in association with the example presentation GUIs described above with respect to FIGS. 3A-3C and 5. For instance, the various device(s) and/or module(s) in FIGS. 1 and/or 2 can generate, transmit, receive, and/or display data associated with content of a communication session (e.g., live content, recorded content, etc.) and/or a presentation GUI that includes display of one or more participants or avatars associated with a communication session.

FIG. 4 is a diagram of an example flowchart 400 that illustrates operations directed a presentation GUI in association with a communication session. In one example, the operations of FIG. 4 can be performed by components of the system 102, environment 100, and/or a client computing device 106.

At operation 402, components of the environment 100 may provide a presentation GUI. The presentation GUI may be rendered on a display screen 128. The presentation GUI may include regions, areas or grid sections that may be populated with video feeds or still images associated with communication data 138.

At operation 404, components of the environment 100 may analyze the video feeds or the still images associated with communication data 138 to ascertain the context associated with the video feeds or still images.

At operation 406, components of the environment 100 may populate a first of the plurality grid sections with a first video feed or a first still image of the video feeds or the still images.

At operation 408, components of the environment 100 may populate second of the plurality grid sections with a second video feed or a second still image of the video feeds for the still images. In some implementations, the operations 406 and 408 may be based on the context associated with the video feeds or the still images associated with the communication data 138.

At operation 410, where the operation 410 may be integral with the operations 406 and/or 408, or omitted, the environment 100 may adjust a presentation of the second video feed or the second still image based on the context associated with the video feeds or the still images associated with the communication data 138.

The implementation illustrated in FIG. 5 shows that the system 102 populated the sections 306 in manner the considers a context of the communication session 104. For example, compared to FIG. 3A, the second participant is rendered in the section or region 306(1) and the first participant is rendered in the section or region 306(2). In some implementations, the second participant is the dominant participant or the presenter in the communication session 104. Furthermore, compared to FIG. 3A, the fourth participant is rendered in the section 306(3) and the third participant is rendered in section or region 306(4). Rendering or arranging the participants as illustrated in FIG. 5 takes into consideration the context of the communication session 104. Specifically, populating the presentation GUI 300 in the manner illustrated in FIG. 5 accurately represents that at least the second participant and/or the fourth participant are observing the first participant. Rendering or arranging the participants in a manner the considers a context of the communication session 104 may be used alone or in conjunction with the adjusting techniques described with reference to FIGS. 3A-3C and 4.

In some implementations, populating the presentation GUI 300 may be influenced by a participant's physical location in a meeting room or other location associated with the communication session 104. For example, the sections or regions 306 may be populated or rendered with participant feeds in a manner the substantially reflects participant location at the physical location. Additionally, participant renderings in the presentation GUI 300 may be scaled in a manner that normalizes one or more of the participant renderings in the presentation GUI 300. For example, the system 102 may scale one or more of other participant renderings in the presentation GUI 300 to generate a plurality of participate renderings in the presentation GUI 300 that have similar or the same scaling.

In some implementations, the system 102 analyzes a context of the communication session 104 and the associated communication data 138 when display of one or more participants associated with the exemplary presentation GUI 300. In some implementations, the system 102, as part of the context analysis, determines if there is a dominant participant active in the communication session 104. The system 102 may determine that a participant is dominating the communication session 104 based on a percentage of time that the participant is active in the communication session 104. For example, the system 100 to may determine a participant is dominating the communication session 104 based on verbal activity, sharing of content, the participant who organized the communication session 104, and so forth. In other implementations, the dominant participant in the communication session 104 may be predetermined. The relative dominance of one or more participants with respect to other participants is discussed in greater detail in the following.

In some implementations, the system 102 analyzes the context of the communication session 104 using at least face recognition technology. For example, facial recognition technology may be used to determine that the audience member is looking at or facing the presenter, or that the audience member is looking away or not facing the presenter. For example, face recognition technology is able to analyze facial features (e.g., eyes, ears, nose, face shadowing, etc.) to determine in which direction a face rendered in an image, video or avatar is directed.

As illustrated, the GUI 300 may also include the five user interface elements (UIE) 302 labeled 302(1) through 302(5). More specifically, the GUI 300 may include the video on/off UIE 302(1) to enable the user to control whether video is streamed from the user's client computing device in association with the communication session 104, the audio on/off UIE 302(2) to enable the user to control whether audio is streamed from the user's client computing device in association with the communication session 104, the share-control UIE 302(3) to enable the user to selectively expose and/or hide a share-tray GUI, the additional control UIE 302(4) to enable the user to selectively expose and/or hide additional controls in association with the communication session 104, and the “hang up” UIE 302(5) to enable the user to exit the communication session 104.

In various implementations, the relative dominance of one or more participants with respect to other participants may be determined automatically by the system 102 based on various factors such as, for example, an amount of audio content streaming in association with that participant's client device (e.g., if a particular user is speaking the most during the communication session 104 the system 102 may determine that participant to be the most dominant participant), whether a particular participant is currently sharing content such as a display screen or a video file in association with the communication session 104, or any other factor suitable for determining which stream(s) 134 are should be rendered within the persistent view 304 and/or particular regions 306 thereof. As further illustrated, the GUI 300 may include a mirror-view region 308 that displays to the user on the user's own device how the user appears to other participants of the communication session 104 within a corresponding region 306 on the other participants' client computing devices.

### EXAMPLE CLAUSES

The disclosure presented herein may be considered in view of the following clauses.

Example Clause 1. A system, comprising: one or more processing units; and a computer-readable medium having encoded thereon computer-executable instructions to cause the one or more processing units to: provide a presentation graphical user interface (GUI), the presentation GUI to be populated with video feeds or still images associated with communication data; analyze the video feeds or the still images associated with the communication data to ascertain a context associated with the video feeds or the still images; populate the presentation GUI with a first video feed or a first still image of the video feeds or the still images; and populate the presentation GUI with a second video feed or a second still image of the video feeds or the still images, wherein populating the presentation GUI is at least based on the context associated with the video feeds or the still images.

Example Clause 2. The system of Clause 1, wherein the communication data is associated with a communication session comprising the first video feed and the second video feed, the first video feed comprising at least one individual presenting and the second video feed comprising at least one individual observing the at least one individual presenting.

Example Clause 3. The system of Clause 2, wherein the context associated with the video feeds or the still images is a determination that the second video feed comprises the at least one individual observing the at least one individual presenting in the first video feed, and the populating the presentation GUI comprises populating the presentation GUI with the second video feed such that the at least one individual represented in the second video feed is facing the at least one individual presenting in the first video feed.

Example Clause 4. The system of Clause 1, wherein the communication data is associated with a communication session comprising the first video feed and the second still image, the first video feed comprising at least one individual presenting and the second still image comprising an image or avatar associated with at least one individual observing the at least one individual presenting.

Example Clause 5. The system of Clause 4, wherein the context associated with the video feeds or the still images is a determination that the second video feed comprises the image or avatar associated with at least one individual observing the at least one individual presenting, and the populating the presentation GUI comprises populating the presentation GUI with the second still image such that the image or avatar associated with at least one individual observing the at least one individual presenting is facing the at least one individual presenting in the first video feed.

Example Clause 6. A method, comprising: providing a presentation graphical user interface (GUI), the presentation GUI to be populated with video feeds or still images associated with communication data; analyzing the video feeds or the still images associated with the communication data to ascertain a context associated with the video feeds or the still images; populating the presentation GUI with a first video feed or a first still image of the video feeds or the still images; and populating the presentation GUI with a second video feed or a second still image of the video feeds or the still images, wherein populating the presentation GUI with the second video feed or the second still image includes adjusting a presentation of the second video feed or the second still image based on the context associated with the video feeds or the still images associated with the communication data.

Example Clause 7. The method of Clause 6, wherein the adjusting the presentation of the second video feed or the second still image based on the context associated with the video feeds or the still images associated with the communication data includes zooming or enlarging at least a portion of the second video feed or the second still image.

Example Clause 8. The method of Clause 6, wherein the adjusting the presentation of the second video feed or the second still image based on the context associated with the video feeds or the still images associated with the communication data includes flipping horizontally the second video feed or the second still image.

Example Clause 9. The method of Clause 6, wherein the communication data is associated with a communication session comprising the first video feed and the second video feed, the first video feed comprising at least one individual presenting and the second video feed comprising at least one individual observing the at least one individual presenting.

Example Clause 10. The method of Clause 9, wherein the context associated with the video feeds or the still images is a determination that the second video feed comprises the at least one individual observing the at least one individual presenting in the first video feed, and the adjusting the presentation of the second video feed or the second still image comprises populating the presentation GUI with the second video feed such that the at least one individual represented in the second video feed is facing the at least one individual presenting in the first video feed.

Example Clause 11. The method of Clause 10, wherein populating the presentation GUI with the second video feed comprises flipping horizontally the at least individual represented in the second video feed.

Example Clause 12. The method of Clause 6, wherein the communication data is associated with a communication session comprising the first video feed and the second still image, the first video feed comprising at least one individual presenting and the second still image comprising an image or avatar associated with at least one individual observing the at least one individual presenting.

Example Clause 13. The method of Clause 12, wherein the context associated with the video feeds or the still images is a determination that image or avatar is associated with the at least one individual observing the at least one individual presenting in the first video feed, and the adjusting the presentation of the second video feed or the second still image comprises populating the presentation GUI with the image or avatar associated with at least one individual observing the at least one individual presenting such that the image or avatar is facing the at least one individual presenting in the first video feed.

Example Clause 14. A system, comprising: means for providing a presentation graphical user interface (GUI), the presentation GUI to be populated with video feeds or still images associated with communication data; means for analyzing the video feeds or the still images associated with the communication data to ascertain a context associated with the video feeds or the still images; means for populating the presentation GUI with a first video feed or a first still image of the video feeds or the still images; and means for populating the presentation GUI with a second video feed or a second still image of the video feeds or the still images, wherein populating the presentation GUI with the first video feed or the first still image and the second video feed or the second still image is at least based on the context associated with the video feeds or the still images.

Example Clause 15. The system of Clause 14, wherein the communication data is associated with a communication session comprising the first video feed and the second video feed, the first video feed comprising at least one individual presenting and the second video feed comprising at least one individual observing the at least one individual presenting.

Example Clause 16. The system of Clause 15, wherein the context associated with the video feeds or the still images is a determination that the second video feed comprises the at least one individual observing the at least one individual presenting in the first video feed, and the populating the presentation GUI comprises populating the presentation GUI with the second video feed such that the at least one individual represented in the second video feed is facing the at least one individual presenting in the first video feed.

Example Clause 17. The system of Clause 14, wherein the communication data is associated with a communication session comprising the first video feed and the second still image, the first video feed comprising at least one individual presenting and the second still image comprising an image or avatar associated with at least one individual observing the at least one individual presenting.

Example Clause 18. The system of Clause 17, wherein the context associated with the video feeds or the still images is a determination that the second video feed comprises the image or avatar associated with at least one individual observing the at least one individual presenting, and the populating the presentation GUI comprises populating the presentation GUI with the second still image such that the image or avatar associated with at least one individual observing the at least one individual presenting is facing the at least one individual presenting in the first video feed.

Example Clause 19. The system of Clause 14, wherein the populating the presentation GUI with the first video feed or the first still image and the second video feed or the second still image includes flipping horizontally the second video feed or the second still image.

Example Clause 20. The system of Clause 14, wherein the populating the presentation GUI with the first video feed or the first still image and the second video feed or the second still image includes populating the presentation GUI with the second still image and flipping horizontally the second still image.

Although the techniques have been described in language specific to structural features and/or methodological acts, it is to be understood that the appended claims are not necessarily limited to the features or acts described. Rather, the features and acts are described as example implementations of such techniques.

The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as FPGAs, DSPs, or other types of accelerators.

All of the methods and processes described above may be embodied in, and fully automated via, software code modules executed by one or more general purpose computers or processors. The code modules may be stored in any type of computer-readable storage medium or other computer storage device. Some or all of the methods may alternatively be embodied in specialized computer hardware.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art. It should be emphasized that many variations and modifications may be made to the above-described examples, the elements of which are to be understood as being among other acceptable examples. All such modifications and variations are intended to be included herein within the scope of this disclosure and protected by the following claims.

1. A system, comprising:
one or more processing units; and
a computer-readable medium having encoded thereon computer-executable instructions to cause the one or more processing units to:
provide a presentation graphical user interface (GUI), the presentation GUI to be populated with video feeds or still images associated with communication data;
analyze the video feeds or the still images associated with the communication data to ascertain a context associated with the video feeds or the still images, ascertaining the context including determining at least one individual represented by the video feeds or still images is observing at least one individual presenting in the video feeds or still images;
populate the presentation GUI with a first video feed or a first still image of the video feeds or the still images; and
populate the presentation GUI with a second video feed or a second still image of the video feeds or the still images,
wherein populating the presentation GUI is at least based on the context associated with the video feeds or the still images and includes adjusting an orientation of the first video feed or the first still image, or the second video feed or the second still image, adjusting the orientation altering a gaze direction of an individual represented by the first video feed or the first still image, or the second video feed or the second still image.

2. The system of claim 1, wherein the communication data is associated with a communication session comprising the first video feed and the second video feed, the first video feed comprising at least one individual presenting and the second video feed comprising at least one individual observing the at least one individual presenting.

3. The system of claim 2, wherein the context associated with the video feeds or the still images is a determination that the second video feed comprises the at least one individual observing the at least one individual presenting in the first video feed, and the populating the presentation GUI comprises populating the presentation GUI with the second video feed such that the at least one individual represented in the second video feed is facing the at least one individual presenting in the first video feed.

4. The system of claim 1, wherein the communication data is associated with a communication session comprising the first video feed and the second still image, the first video feed comprising at least one individual presenting and the second still image comprising an image or avatar associated with at least one individual observing the at least one individual presenting.

5. The system of claim 4, wherein the context associated with the video feeds or the still images is a determination that the second video feed comprises the image or avatar associated with at least one individual observing the at least one individual presenting, and the populating the presentation GUI comprises populating the presentation GUI with the second still image such that the image or avatar associated with at least one individual observing the at least one individual presenting is facing the at least one individual presenting in the first video feed.

6. A computer-implemented method for populating a presentation graphical user interface (GUI), the method comprising:
providing a presentation GUI, the presentation GUI to be populated with video feeds or still images associated with communication data and to display on a computer display;
analyzing the video feeds or the still images associated with the communication data to ascertain a context associated with the video feeds or the still images, ascertaining the context including determining at least one individual represented by the video feeds or still images is observing at least one individual represented as presenting in the video feeds or still images;
populating the presentation GUI with a first video feed or a first still image of the video feeds or the still images; and
populating the presentation GUI with a second video feed or a second still image of the video feeds or the still images,
wherein populating the presentation GUI with the second video feed or the second still image includes adjusting a presentation of the second video feed or the second still image based on the context associated with the video feeds or the still images associated with the communication data, the adjusting the presentation altering a gaze direction of an individual represented by the second video feed or the second still image.

7. The method of claim 6, wherein the adjusting the presentation of the second video feed or the second still image based on the context associated with the video feeds or the still images associated with the communication data includes zooming or enlarging at least a portion of the second video feed or the second still image when it is detected that the individual represented by the second video feed or the second still image is making a gesture.

8. The method of claim 6, wherein the adjusting the presentation of the second video feed or the second still image based on the context associated with the video feeds or the still images associated with the communication data includes flipping horizontally the second video feed or the second still image.

9. The method of claim 6, wherein the communication data is associated with a communication session comprising the first video feed and the second video feed, the first video feed comprising at least one individual presenting and the second video feed comprising at least one individual observing the at least one individual presenting.

10. The method of claim 9, wherein the context associated with the video feeds or the still images is a determination that the second video feed comprises the at least one individual observing the at least one individual presenting in the first video feed, and the adjusting the presentation of the second video feed or the second still image comprises populating the presentation GUI with the second video feed such that the at least one individual represented in the second video feed is facing the at least one individual presenting in the first video feed.

11. The method of claim 10, wherein populating the presentation GUI with the second video feed comprises flipping horizontally the at least individual represented in the second video feed.

12. The method of claim 6, wherein the communication data is associated with a communication session comprising the first video feed and the second still image, the first video feed comprising at least one individual presenting and the second still image comprising an image or avatar associated with at least one individual observing the at least one individual presenting.

13. The method of claim 12, wherein the context associated with the video feeds or the still images is a determination that image or avatar is associated with the at least one individual observing the at least one individual presenting in the first video feed, and the adjusting the presentation of the second video feed or the second still image comprises populating the presentation GUI with the image or avatar associated with at least one individual observing the at least one individual presenting such that the image or avatar is facing the at least one individual presenting in the first video feed.

14. A system, comprising:
means for providing a presentation graphical user interface (GUI), the presentation GUI to be populated with video feeds or still images associated with communication data;
means for analyzing the video feeds or the still images associated with the communication data to ascertain a context associated with the video feeds or the still images, ascertaining the context including determining at least one individual represented by the video feeds or still images is observing at least one individual represented as presenting by the video feeds or still images;
means for populating the presentation GUI with a first video feed or a first still image of the video feeds or the still images; and
means for populating the presentation GUI with a second video feed or a second still image of the video feeds or the still images,
wherein populating the presentation GUI with the first video feed or the first still image and the second video feed or the second still image is at least based on the context associated with the video feeds or the still images and includes adjusting an orientation of the first video feed or the first still image, or the second video feed or the second still image, adjusting the orientation altering a gaze direction of an individual represented by the first video feed or the first still image, or the second video feed or the second still image.

15. The system of claim 14, wherein the communication data is associated with a communication session comprising the first video feed and the second video feed, the first video feed comprising at least one individual presenting and the second video feed comprising at least one individual observing the at least one individual presenting.

16. The system of claim 15, wherein the context associated with the video feeds or the still images is a determination that the second video feed comprises the at least one individual observing the at least one individual presenting in the first video feed, and the populating the presentation GUI comprises populating the presentation GUI with the second video feed such that the at least one individual represented in the second video feed is facing the at least one individual presenting in the first video feed.

17. The system of claim 14, wherein the communication data is associated with a communication session comprising the first video feed and the second still image, the first video feed comprising at least one individual presenting and the second still image comprising an image or avatar associated with at least one individual observing the at least one individual presenting.

18. The system of claim 17, wherein the context associated with the video feeds or the still images is a determination that the second video feed comprises the image or avatar associated with at least one individual observing the at least one individual presenting, and the populating the presentation GUI comprises populating the presentation GUI with the second still image such that the image or avatar associated with at least one individual observing the at least one individual presenting is facing the at least one individual presenting in the first video feed.

19. The system of claim 14, wherein the populating the presentation GUI with the first video feed or the first still image and the second video feed or the second still image includes flipping horizontally the second video feed or the second still image and further includes zooming or enlarging at least a portion of the second video feed or the second still image when it is detected that the individual represented by the second video feed or the second still image is making a gesture.

20. The system of claim 14, wherein the populating the presentation GUI with the first video feed or the first still image and the second video feed or the second still image includes populating the presentation GUI with the second still image and flipping horizontally the second still image.
